(19) United States
(12) Patent Application Publication
(10) Pub. No.: US 2022/0225801 A1
(43) Pub. Date: Jul. 21, 2022

(54) Hot Beverage Steeping Assembly

(71) Applicant: Kim Brownlee, La Verne, CA (US)

(72) Inventor: Kim Brownlee, La Verne, CA (US)

(21) Appl. No.: 17/151,818

(22) Filed: Jan. 19, 2021

(51) Int. Cl. A47G 19/16; A47J 31/20

(52) U.S. Cl. CPC A47G 19/16; A47J 31/20

(57) ABSTRACT

A hot beverage steeping assembly includes a pouch which encloses brewing granules. The pouch is comprised of a fluid permeable material for submerging in a cup of water to steeping the brewing granules in the water to produce a beverage. A dunking can is provided that has a plurality of inlets each extending into an interior of the dunking can to pass the water into the dunking can when the dunking can is submerged in the cup of water. The pouch is insertable into the dunking can such that the dunking can suspends the pouch in the water for steeping. A handle is coupled to and extends upwardly from the dunking can for submerging the dunking can in the cup of water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to steeping device and more particularly pertains to a new steeping device for steeping brewing granules that would normally be poured directly into water. The steeping device includes a pouch that contains the brewing granules and a dunking can for submerging the pouch in the water.

### (2) Description of Related Art Including Information Disclosed Under 37 CFR 1.97 and 1.98

The prior art relates to steeping device including a variety of fluid permeable pouches that can be submerged in water for producing a beverage. The prior art also discloses a variety of beverage brewing devices that include a water container and a water soluble capsule that can be inserted into the water container for producing a beverage.

### BRIEF SUMMARY OF THE INVENTION

An embodiment of the disclosure meets the needs presented above by generally comprising a pouch which encloses brewing granules. The pouch is comprised of a fluid permeable material for submerging in a cup of water to steeping the brewing granules in the water to produce a beverage. A dunking can is provided that has a plurality of inlets each extending into an interior of the dunking can to pass the water into the dunking can when the dunking can is submerged in the cup of water. The pouch is insertable into the dunking can such that the dunking can suspends the pouch in the water for steeping. A handle is coupled to and extends upwardly from the dunking can for submerging the dunking can in the cup of water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hot beverage steeping assembly according to an embodiment of the disclosure.

FIG. 2 is a front view of an embodiment of the disclosure.

FIG. 3 is a back phantom view of an embodiment of the disclosure.

FIG. 4 is a bottom view of an embodiment of the disclosure.

FIG. 5 is a left side view of an embodiment of the disclosure.

FIG. 6 is a perspective in-use view of an embodiment of the disclosure.

### DETAILED DESCRIPTION OF THE INVENTION

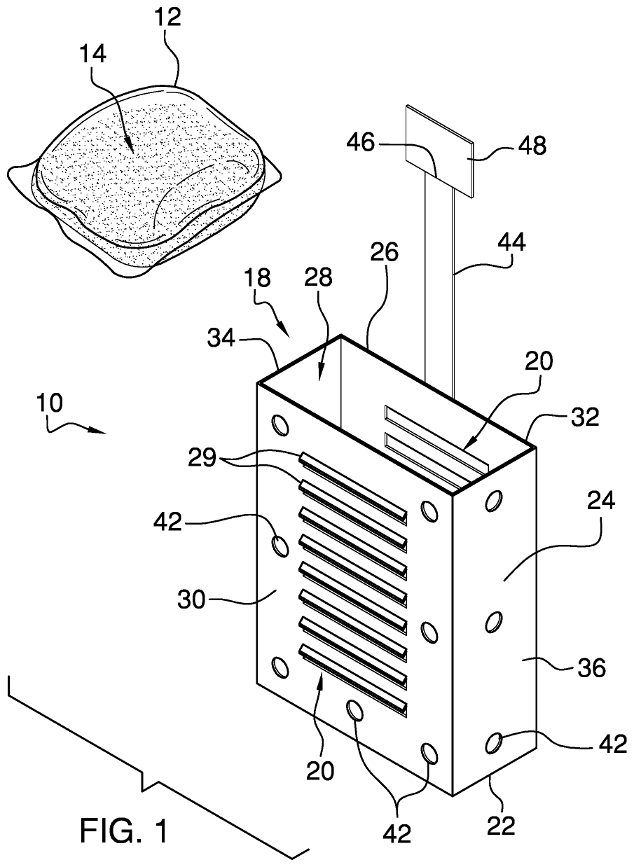

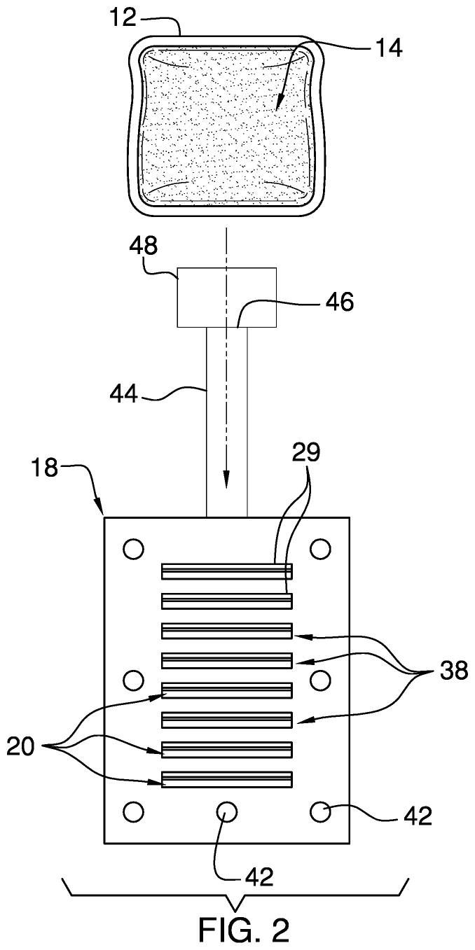

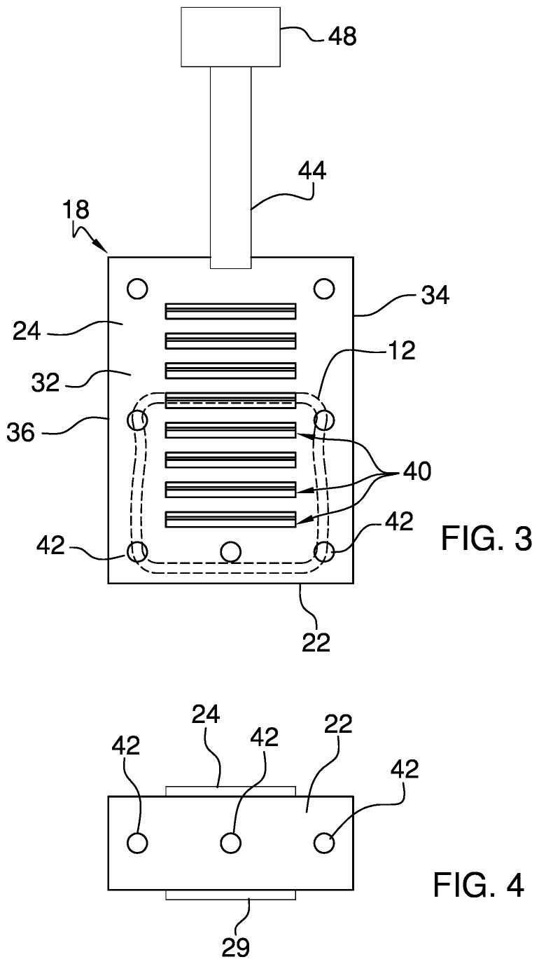

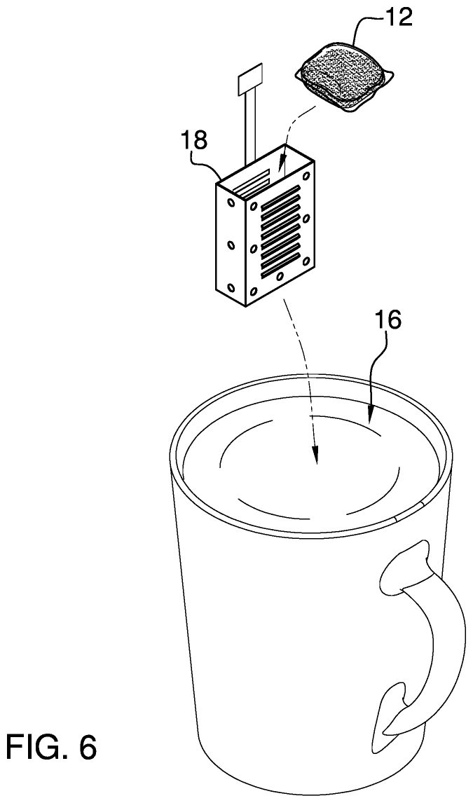

With reference now to the drawings, and in particular to FIGS. 1 through 6 thereof, a new steeping device embodying the principles and concepts of an embodiment of the disclosure and generally designated by the reference numeral 10 will be described.

As best illustrated in FIGS. 1 through 6, the hot beverage steeping assembly 10 generally comprises a pouch 12 that encloses brewing granules 14. The pouch 12 is comprised of a fluid permeable material thereby facilitating the pouch 12 to steep the brewing granules 14 in a cup of water 16 to produce a beverage. The brewing granules 14 may be powdered cocoa, instant coffee, tea or any other type of brewing granules that would typically be poured directly into the water 16 to produce the beverage. The pouch 12 ensures that the brewing granules 14 are not spilled, making the pouch 12 a functional choice for an airline flight attendant, for example, to make a beverage without spilling the brewing granules 14.

A dunking can 18 is provided and the dunking can 18 has a plurality of inlets 20 each extending into an interior of the dunking can 18. In this way each of the inlets 20 passes the water 16 into the dunking can 18 when the dunking can 18 is submerged in the cup of water 16. The pouch 12 is insertable into the dunking can 18 to suspend the pouch 12 in the water 16 for steeping. The dunking can 18 has a bottom wall 22 and an outer wall 24 extending upwardly therefrom, and the outer wall 24 has a distal edge 26 with respect to the bottom wall 22 defining an opening 28 into the dunking can 18 for receiving the pouch 12. The outer wall 24 may have a plurality of flaps 29 angling downwardly therefrom and each of the flaps 29 may extend along a respective one of the inlets 20.

The outer wall 24 has a front side 30, a back side 32, a first lateral side 34 and a second lateral side 36. The plurality of inlets 20 includes a set of first inlets 38 each extending through the front side 30. Additionally, the plurality of inlets 20 includes a set of second inlets 40 each extending through the back side 32. The outer wall 24 has a plurality of apertures 42 each extending into the interior of the dunking can 18 to pass water 16 into the dunking can 18. The apertures 42 are spaced apart from each other and are distributed around the front side 30, the first lateral side 34 and the second lateral side 36. Additionally, the bottom wall 22 has a plurality of the apertures 42 extending therethrough to pass water 16 into the dunking can 18.

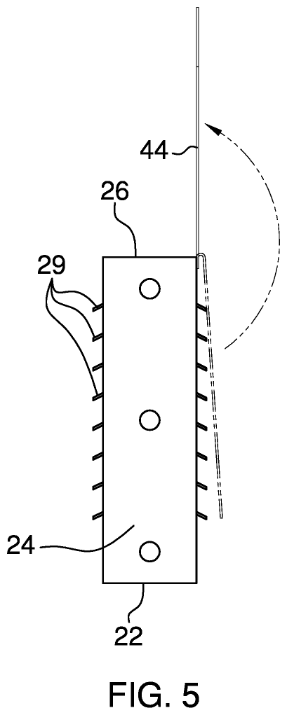

A handle 44 is provided and the handle 44 is movably coupled to the dunking can 18. As is most clearly shown in FIG. 5, the handle is positionable in a deployed position having the handle 44 extending upwardly from the distal edge 26 of the outer wall 24 of the dunking can 18. In this way the handle 44 can be gripped for submerging the dunking can 18 in the cup of water 16. The handle 44 can be positioned in a stored position having the handle 44 lying flat against the outer wall 24. The handle 44 has a distal end 46 with respect to the distal edge 26 and the handle 44 is centrally positioned on the back side 32 of the outer wall 24. A grip 48 is positioned on the distal end 46 and the grip 48 is elongated along a line that is oriented perpendicular to the handle 44 to enhance gripping the handle 44.

In use, the pouch 12 is inserted into the dunking can 18 and the dunking can 18 is lowered into the cup of water 16. In this way the brewing granules 14 can be steeped, rather than poured directly, into the water 16 to produce the beverage. Thus, the beverage can be produced without the risk of spilling the brewing granules 14. The dunking can 18 may be stirred or agitated in the water 16 to enhance the process of producing the beverage. The dunking can 18 is lifted out of the water 16 and the pouch 12 is discarded after sufficient time to produce the beverage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hot beverage steeping assembly for steeping a hot beverage, said assembly comprising:
a pouch enclosing brewing granules, said pouch being comprised of a fluid permeable material wherein said pouch is configured to be submerged in a cup of water for steeping said brewing granules in the water to produce a beverage;
a dunking can having a plurality of inlets each extending into an interior of said dunking can wherein each of said inlets is configured to pass the water into said dunking can when said dunking can is submerged in the cup of water, said pouch being insertable into said dunking can wherein said dunking can is configured to suspend said pouch in the water for steeping; and
a handle being coupled to and extending upwardly from said dunking can wherein said handle is configured to be gripped for submerging said dunking can in the cup of water.

2. The assembly according to claim 1, wherein said dunking can has a bottom wall and an outer wall extending upwardly therefrom, said outer wall having a distal edge with respect to said bottom wall defining an opening into said dunking can for receiving said pouch, said outer wall having a front side, a back side, a first lateral side and a second lateral side.

3. The assembly according to claim 2, wherein said plurality of inlets includes a set of first inlets each extending through said front side, said plurality of inlets including a set of second inlets each extending through said back side.

4. The assembly according to claim 2, wherein said outer wall has a plurality of apertures each extending into said interior of said dunking can wherein each of said apertures is configured to pass water into said dunking can, said apertures being spaced apart from each other and being distributed around said front side, said first lateral side and said second lateral side.

5. The assembly according to claim 4, wherein said bottom wall has a plurality of said apertures extending therethrough wherein said apertures in said bottom wall are configured to pass water into said dunking can.

6. The assembly according to claim 2, wherein said handle extends upwardly from said distal edge of said outer wall of said dunking can, said handle having a distal end with respect to said distal edge, said handle being centrally positioned on said back side of said outer wall.

7. The assembly according to claim 6, wherein said handle has a grip being positioned on said distal end, said grip being elongated along a line being oriented perpendicular to said handle wherein said grip is configured to enhance gripping said handle.

8. A hot beverage steeping assembly for steeping a hot beverage, said assembly comprising:
a pouch enclosing brewing granules, said pouch being comprised of a fluid permeable material wherein said pouch is configured to be submerged in a cup of water for steeping said brewing granules in the water to produce a beverage;
a dunking can having a plurality of inlets each extending into an interior of said dunking can wherein each of said inlets is configured to pass the water into said dunking can when said dunking can is submerged in the cup of water, said pouch being insertable into said dunking can wherein said dunking can is configured to suspend said pouch in the water for steeping, said dunking can having a bottom wall and an outer wall extending upwardly therefrom, said outer wall having a distal edge with respect to said bottom wall defining an opening into said dunking can for receiving said pouch, said outer wall having a front side, a back side, a first lateral side and a second lateral side, said plurality of inlets including a set of first inlets each extending through said front side, said plurality of inlets including a set of second inlets each extending through said back side, said outer wall having a plurality of apertures each extending into said interior of said dunking can wherein each of said apertures is configured to pass water into said dunking can, said apertures being spaced apart from each other and being distributed around said front side, said first lateral side and said second lateral side, said bottom wall having a plurality of said apertures extending therethrough wherein said apertures in said bottom wall are configured to pass water into said dunking can; and
a handle being coupled to and extending upwardly from said dunking can wherein said handle is configured to be gripped for submerging said dunking can in the cup of water, said handle extending upwardly from said distal edge of said outer wall of said dunking can, said handle having a distal end with respect to said distal edge, said handle being centrally positioned on said back side of said outer wall, said handle having a grip being positioned on said distal end, said grip being elongated along a line being oriented perpendicular to said handle wherein said grip is configured to enhance gripping said handle.
